(19) United States
(12) Patent Application Publication
(10) Pub. No.: US 2025/0314810 A1
(43) Pub. Date: Oct. 9, 2025

(54) PRODUCING GRATINGS IN OPTICAL SUBSTRATES USING NEUTRALIZED ION BEAM ETCHING

(71) Applicant: GOOGLE LLC, Mountain View, CA (US)

(72) Inventors: Eric Anthony Perozziello, Discovery Bay, CA (US); Maria Esther Pace, Palo Alto, CA (US); Bernard C. Kress, Redwood City, CA (US)

(21) Appl. No.: 18/627,835

(22) Filed: Apr. 5, 2024

(51) Int. Cl. G02B 5/18

(52) U.S. Cl. CPC G02B 5/1857

(57) ABSTRACT

Various techniques for producing gratings in optical substrates include using neutralized ion beam etching. The gratings are used in waveguides or other optical devices. By utilizing neutralized ion beam etching, blazed and other optical gratings can be produced on an optical substrate with high precision and accuracy. The various gratings disclosed herein are utilized as reflective or refractive gratings, a portion of an incoupler, outcoupler, or exit pupil expander in an optical waveguide or lightguide, an echelette grating, or as part of a spectral filtering or spectroscopic system, among others.

### BACKGROUND

In head-mounted displays (HMDs), light from an image source is coupled into a lightguide substrate, generally referred to as a waveguide, by an optical input coupling element, such as an in-coupling grating (i.e., an “input coupler” or “incoupler”), which can be formed on a surface, or multiple surfaces, of the substrate or disposed within the substrate. Once the light beams have been coupled into the waveguide, the light beams are “guided” through the substrate, typically by multiple instances of total internal reflection (TIR) or by a coated surface(s). The guided light beams are then directed out of the waveguide by an output optical coupling (i.e., an “output coupler” or “outcoupler”), which can also take the form of an optical grating (e.g., a diffractive, reflective, or refractive grating). The output coupler directs the light at an eye relief distance from the waveguide, forming an exit pupil within which a virtual image generated by the image source can be viewed by a user of the display device. In many instances, an exit pupil expander, which can also take the form of an optical grating, is arranged in an intermediate stage between the input coupler and output coupler to receive light that is coupled into the waveguide by the input coupler, expand the light, and redirect the light towards the output coupler.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system with a waveguide having a plurality of sections and incouplers in accordance with some embodiments.

FIG. 2 is a diagram illustrating a cross-section view of an example implementation of the waveguide of FIG. 1 in accordance with some embodiments.

FIG. 3 shows an example of light propagation within a waveguide implementing a one-dimensional grating in accordance with some embodiments.

FIG. 4 shows an example of light propagation within a waveguide implementing a two-dimensional grating in accordance with some embodiments.

FIG. 5 shows an example of a blazed grating in accordance with some embodiments.

FIG. 6 shows a first step of producing a blazed grating like that of FIG. 5 in accordance with some embodiments.

FIG. 7 shows a second step of producing a blazed grating like that of FIG. 5 in accordance with some embodiments.

FIG. 8 shows a third step of producing a blazed grating like that of FIG. 5 in accordance with some embodiments.

FIG. 9 shows a fourth step of producing a blazed grating like that of FIG. 5 in accordance with some embodiments.

FIG. 10 shows an example of a blazed grating with flattened upper edges in accordance with some embodiments.

FIG. 11 shows an example step of applying a coating to a blazed grating in accordance with some embodiments.

FIG. 12 shows an example of a partially coated blazed grating in accordance with some embodiments.

FIG. 13 shows an example of a blazed grating with different coatings on different surfaces in accordance with some embodiments.

FIG. 14 shows an example of a blazed grating with a curved surface in accordance with some embodiments.

FIG. 15 shows an example step of producing a slanted grating in accordance with some embodiments.

FIG. 16 shows an example of a producing a grating with reentrant profiles in accordance with some embodiments.

FIG. 17 shows an example method of producing a blazed grating like that of FIG. 5 in accordance with some embodiments.

FIG. 18 shows an example method of producing a grating with reentrant profiles like that of FIG. 16 in accordance with some embodiments.

### DETAILED DESCRIPTION

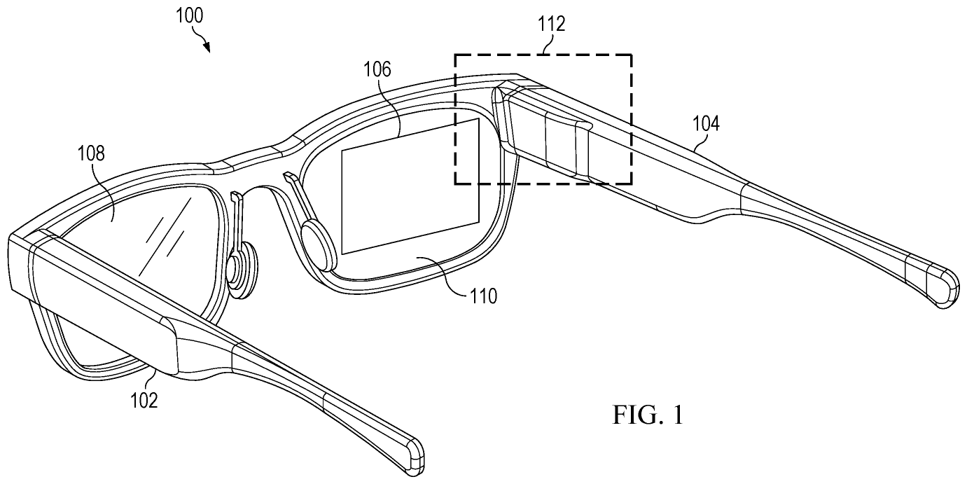

FIGS. 1-18 illustrate various techniques for producing gratings in optical substrates using neutralized ion beam etching and utilizing such gratings in waveguides or other optical devices. In neutralized ion beam etching, an ion beam, typically composed of positively charged ions, is neutralized by introducing electrons or oppositely charged species into the beam. The neutralization process helps to alleviate charging effects that can occur during standard ion beam etching, particularly when dealing with insulating materials. By reducing the net charge of the ion beam, neutralized ion beam etching improves control and selectivity, minimizing potential damage or distortion of sensitive structures compared to other etching technologies. Accordingly, by utilizing neutralized ion beam etching, blazed and other optical gratings can be produced on an optical substrate with high precision and accuracy. In some embodiments, electrically insulating substrates are utilized, as charging effects are minimized when the ion beam is substantially neutralized. Additionally, in some embodiments, a non-neutralized ion beam is used in place of a neutralized ion beam, such as when a substrate is sufficiently conductive to avoid the need for a neutralized ion beam.

In some embodiments, blazed gratings are produced by etching trenches in an optical substrate, applying to the substrate a mask that deposits mask material in the trenches, removing the mask material in locations between the trenches, and applying a slanted etch to the substrate to produce a blazed grating in the substrate. In other embodiments, gratings with reentrant profiles, e.g., profiles having sidewalls that taper inwardly, are produced by etching a trench in an optical substrate, applying a first slanted etch to the substrate to produce a slanted grating in the substrate, modifying a tilt of the substrate or a direction of etching, and applying a second slanted etch to the substrate to produce reentrant profiles in the substrate. The various gratings disclosed herein may be utilized as, e.g., reflective, diffractive, or refractive gratings, a portion of an incoupler, outcoupler, exit pupil expander, or a combination of one or more thereof in an optical waveguide or lightguide, an echelette grating, or as part of a spectral filtering or spectroscopic system, among others.

FIG. 1 illustrates an example display system 100 capable of implementing one or more of the waveguide configurations described herein. It should be understood that the waveguide configurations of one or more embodiments are not limited to display system 100 of FIG. 1 and apply to other display systems. In at least some embodiments, the display system 100 comprises a support structure 102 that includes an arm 104, which houses a light engine configured to project images toward the eye of a user such that the user perceives the projected images as being displayed in a field of view (FOV) area 106 of a display at one or both of lens elements 108, 110. In the depicted embodiment, the display system 100 is a near-eye display system in the form of an eyewear display device that includes the support structure 102 configured to be worn on the head of a user and has a general shape and appearance of an eyeglasses frame. The support structure 102 includes various components to facilitate the projection of such images toward the eye of the user, such as a light engine, an optical scanner, and a waveguide. In at least some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a Wireless Fidelity (WiFi) interface, and the like.

Further, in at least some embodiments, the support structure 102 includes one or more batteries or other portable power sources for supplying power to the electrical components of the display system 100. In at least some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments, the display system 100 may have a different shape and appearance from the eyeglasses frame depicted in FIG. 1.

One or both of the lens elements 108, 110 are used by the display system 100 to provide an augmented reality (AR) or a mixed reality (MR) display in which rendered graphical content is superimposed over or otherwise provided in conjunction with a real-world view as perceived by the user through the lens elements 108, 110. For example, display light used to form a perceptible image or series of images may be projected by a light engine of the display system 100 onto the eye of the user via a series of optical elements, such as a waveguide formed at least partially in the corresponding lens element, one or more scan mirrors, and one or more optical relays. Thus, one or both of the lens elements 108, 110 include at least a portion of a waveguide that routes display light received by an input coupler, or multiple input couplers, of the waveguide to an output coupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In at least some embodiments, the light engine is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The light engine, in at least some embodiments, includes multiple micro-LEDs. The light engine is communicatively coupled to the controller and a non-transitory processor-readable storage medium or memory storing processor-executable instructions and other data that, when executed by the controller, cause the controller to control the operation of the light engine. In at least some embodiments, the controller controls a scan area size and scan area location for the light engine and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

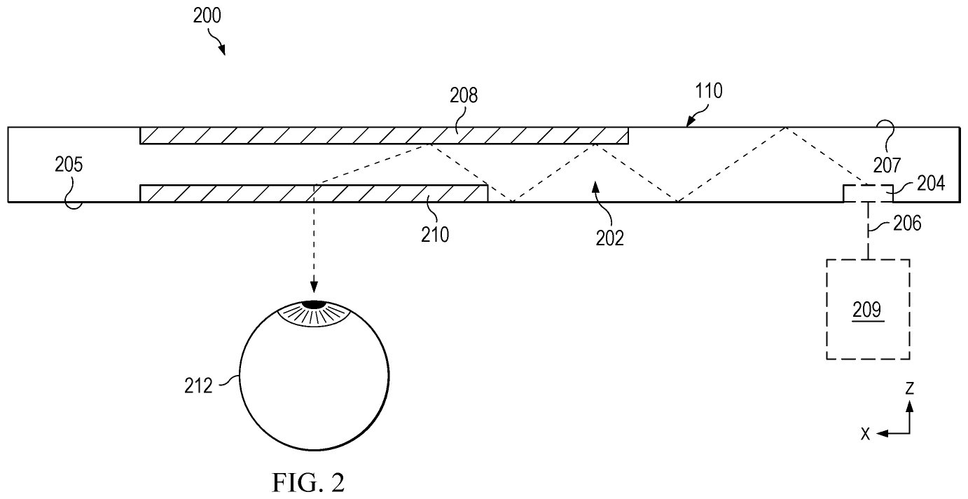

FIG. 2 depicts a cross-section view 200 of an implementation of a lens element 110 of a display system such as the display system 100 of FIG. 1. Note that for purposes of illustration, at least some dimensions in the Z direction are exaggerated for improved visibility of the represented aspects. In this example implementation, a waveguide 202, which may form a portion of the lens element 110 of FIG. 1, implements diffractive optical structures in a region 208 on the opposite side of the waveguide 202 as diffractive optical structures of a region 210. In particular, the reflective, refractive, or diffractive optical structures of an incoupler 204 are implemented on an eye-facing side 205 of the lens element 110. Likewise, the diffractive optical structures of region 210 (which provide outcoupler functionality) are implemented at the eye-facing side 205. Further in the illustrated implementation, the diffractive optical structures of region 208 (which provide EPE functionality) are implemented at a world-facing side 207 of the lens element 110 that is opposite the eye-facing side 205. Thus, under this approach, display light 206 from a light source 209 including components capable of pixel shifting a time-division multiplexed display to produce an increased perceived display resolution is incoupled to the waveguide 202 via the incoupler 204, and propagated (through total internal reflection in this example) toward the region 208, whereupon the optical structures of the region 208 diffract the incident display light for exit pupil expansion purposes, and the resulting light is propagated to the optical structures of the region 210, which output the display light toward a user's eye 212. In other implementations, the positions of regions 208 and 210 may be reversed, with the diffractive optical structures of region 210 formed on the world-facing side 207 and the diffractive optical structures of region 208 formed on the eye-facing side 205, however, this may result in the regions 208 and 210 having different positions, dimensions, and shapes, and also may require diffractive optical structures in each region to have different characteristics.

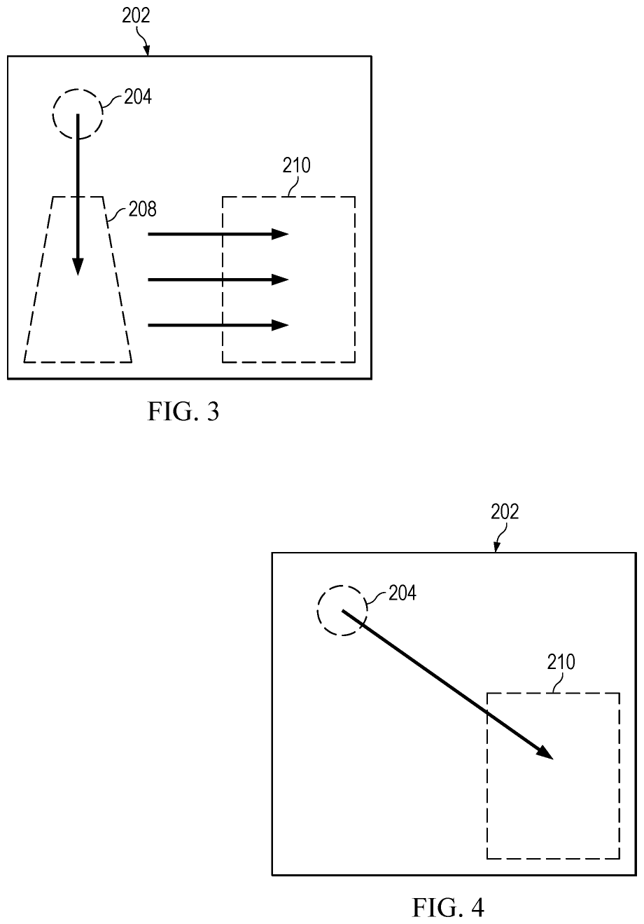

FIG. 3 shows an example of light propagation within the waveguide 202 of FIG. 2 when one-dimensional (1D) gratings are implemented in accordance with some embodiments. As shown, light received via the incoupler 204 is directed into the region 208 and then routed to the region 210 to be output (e.g., toward the eye 212 of the user). In some embodiments, region 208 expands one or more dimensions of the eyebox of a display system (e.g., the display system 100 of FIG. 1) that includes the light source 209 (e.g., with respect to what the dimensions of the eyebox of the display would be without the region 208). In some embodiments, the incoupler 204 and the region 208 each include respective 1D optical gratings (e.g., refractive, diffractive, or reflective gratings that extend along one dimension), which diffract incident light in a particular direction depending on the angle of incidence of the incident light and the structural aspects of the optical gratings. It should be understood that FIG. 3 shows a substantially ideal case in which the incoupler 204 directs light straight down (with respect to the presently illustrated view), and the region 208 directs light to the right (with respect to the presently illustrated view) in a second direction that is perpendicular to the first direction. While not shown in the present example, it should be understood that, in some embodiments, the first direction in which the incoupler 204 directs light is slightly or substantially diagonal.

In at least some embodiments, the region 208 and the region 210 are separated into or onto separate sections of the waveguide 202. For example, the incoupler 204 and the region 208 are located in or on a first section, and the region 210 is located in or on a second section, where a planar direction of the first section is substantially parallel to a planar direction of the second section. In some embodiments, the incoupler 204 and the region 208 are located in or on a first substrate, and the region 210 is located in or on a second substrate, where the first substrate and the second substrate are arranged adjacent to one another in the manners described herein.

The waveguide 202, in at least some embodiments, includes multiple substrates with the region 208 located in or on a first substrate and the region 210 located in or on a second substrate that is separate from and adjacent to the first substrate. In some embodiments, a partition element is placed between the first substrate and the second substrate. For example, the partition element is an airgap (or gas-filled gap), a low-index refractive material layer, a polarizing beam splitter layer, or any combination thereof. In at least some embodiments, the partition element includes additional elements or an opening to direct light from the first substrate to the second substrate.

FIG. 4 shows another example of light propagation within the waveguide 202 of FIG. 2 when two-dimensional gratings (2D) are implemented in accordance with some embodiments. As shown, light received via the incoupler 204 is routed to the region 210 to be output (e.g., toward the eye 212 of the user). In the example shown in FIG. 4, the region 208 is not implemented by the waveguide 202 or is combined with the region 210. If the region 208 is combined with the region 210, the region 208 expands one or more dimensions of the eyebox of the display system as described above. In this example, the region 210 includes a 2D diffraction grating(s) (i.e., a diffraction grating(s) that extends along two dimensions), which diffracts incident light in a particular direction depending on the angle of incidence of the incident light and the structural aspects of the diffraction gratings.

FIG. 5 shows an example of a blazed grating 502 in an optical substrate 504 in accordance with some embodiments, which, along with the other gratings described herein and as noted above, may be utilized as a diffractive, reflective, or refractive grating, a portion of an incoupler, outcoupler, or exit pupil expander in a waveguide, an echelette grating, or as part of a spectral filtering or spectroscopic system, among others. Although only two periods of the blazed grating 502 are shown in FIG. 5, the grating may be reproduced to produce a blazed gratings having any number of desired periods as required for particular applications. In some embodiments, as noted above, neutralized ion beam etching is used to produce blazed gratings such as the blazed grating 502 on an optical substrate such as the optical substrate 504. In neutralized ion beam etching, an ion beam, typically composed of positively charged ions, is neutralized by introducing electrons or oppositely charged species into the beam. The neutralization process helps to alleviate charging effects that can occur during standard ion beam etching, particularly when dealing with insulating materials. By reducing the net charge of the ion beam, neutralized ion beam etching improves control and selectivity, minimizing potential damage or distortion of sensitive structures. In some embodiments, the net charge of the ion beam is neutralized or reduced through introduction of a negative species such as electrons, and, in some embodiments, neutral, chemically reactive species are also introduced into the beam.

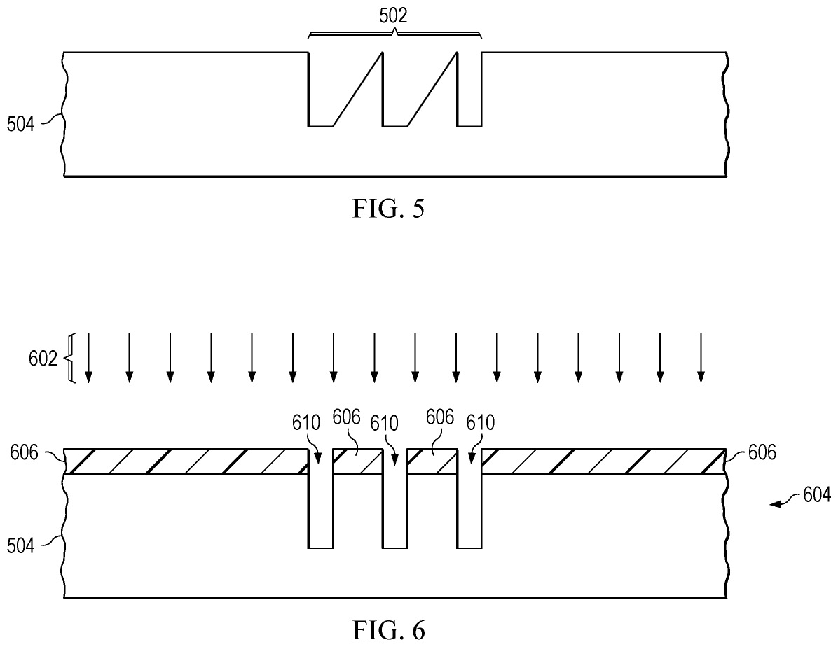

FIGS. 6-9 show various steps that are performed in some embodiments to produce a blazed grating such as the blazed grating 502 of FIG. 5 in an optical substrate such as the optical substrate 504. For example, FIG. 6 shows a first step of producing a blazed grating like that of FIG. 5 in accordance with some embodiments. As shown in FIG. 6, etching 602 is applied to a substrate 604, which in some embodiments includes a mask layer comprising a mask material 606 such as Chromium or Silicon Dioxide and an optical substrate 504 comprising a material such as Quarts or Silicon, to produce trenches 610. Although the etching 602 of FIG. 6 is illustrated as vertical etching, in some embodiments, slanted etching is used to produce the trenches 610.

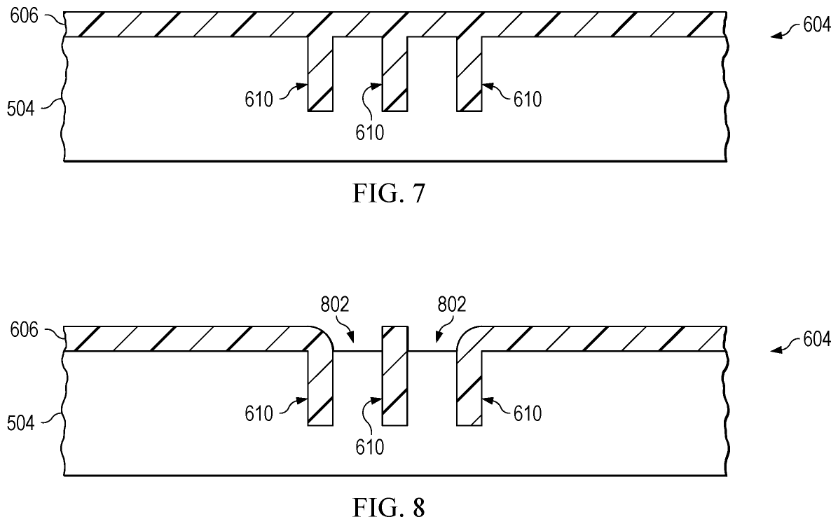

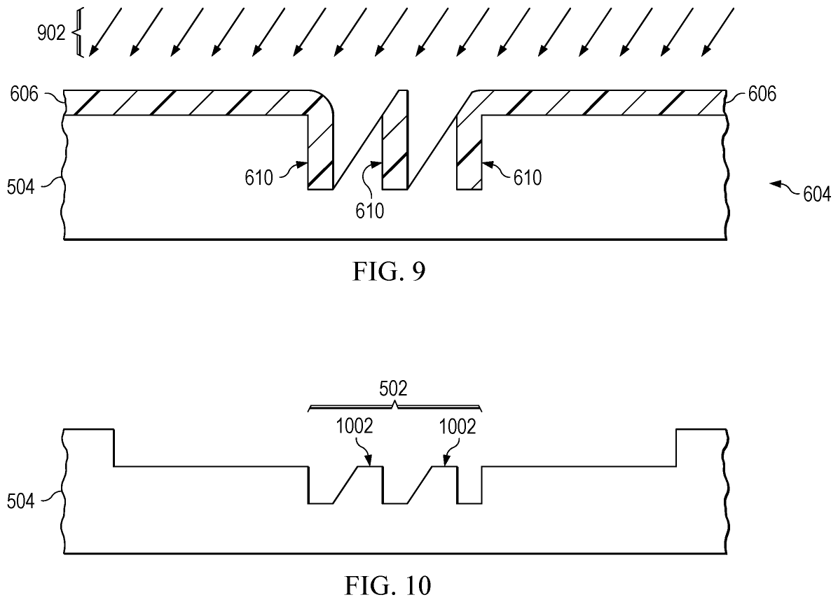

FIG. 7 shows a second step of producing a blazed grating like that of FIG. 5 in accordance with some embodiments, which includes applying a mask to the substrate 604 that deposits mask material 606 in the trenches 610. FIG. 8 shows a third step of producing a blazed grating like that of FIG. 5 in accordance with some embodiments, which includes removing the mask material 606 in locations 802 between the trenches 610, e.g., using an aligned masking photolithography layer. FIG. 9 shows a fourth step of producing a blazed grating like that of FIG. 5 in accordance with some embodiments, which includes applying a slanted etch 902 to the substrate 604 to produce a blazed grating like the blazed grating 502 of FIG. 5 in the optical substrate 504 after removing remaining mask material 606 from the substrate. Notably, in some embodiments, the mask material 606 deposited in the trenches 610 acts as an etch stop, which in the example of FIG. 9 is a vertical etch stop.

FIG. 10 shows an example of a blazed grating with flattened upper edges in accordance with some embodiments. In this example, after removing the remaining mask material 606 (see, e.g., FIG. 9) from the substrate 604, additional material is removed from the optical substrate 504 to flatten upper edges 1002 of the blazed grating 502.

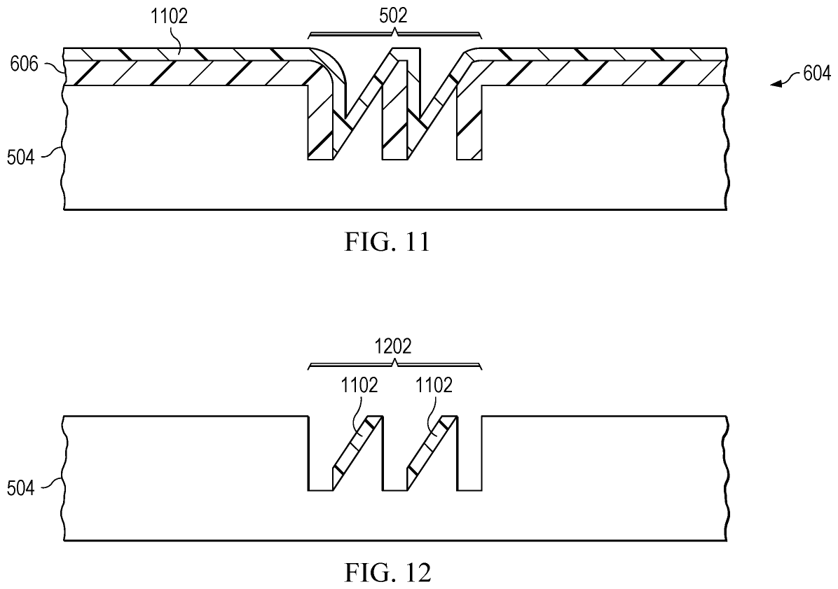

FIGS. 11 and 12 show an example of producing a partially coated blazed grating. For example, FIG. 11 shows an example step of applying a coating to a blazed grating in accordance with some embodiments, which includes applying a coating 1102, such as a reflective or refractive coating, to the substrate after applying the slanted etch 902 of FIG. 9 and prior to removing remaining mask material 606 from the substrate. In some embodiments, the application of coating 1102 is self-aligned to one surface of the substrate. FIG. 12 shows an example of a partially coated blazed grating 1202 in the optical substrate 504 in accordance with some embodiments, which is produced by removing remaining mask material 606 from the substrate 604, leaving behind the coating 1102 on portions of the partially coated blazed grating 1202.

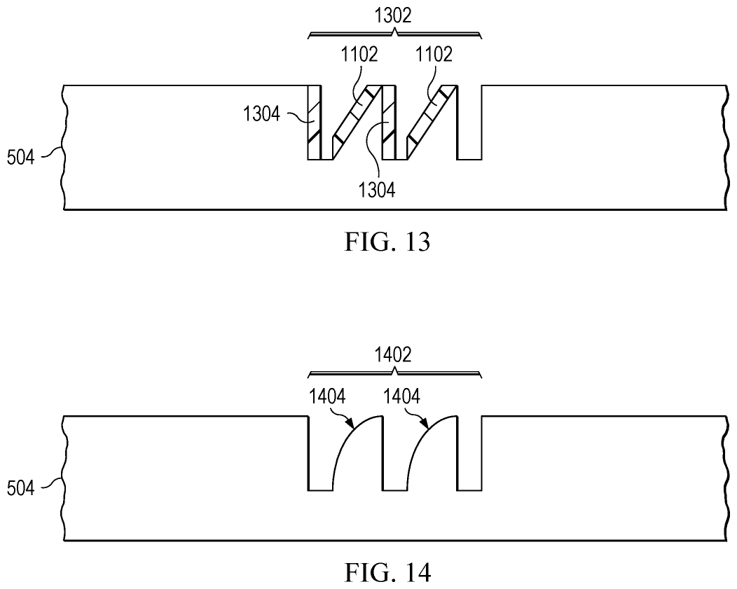

FIG. 13 shows an example of a blazed grating 1302 with different coatings 1102, 1304 on different surfaces in accordance with some embodiments. To produce a blazed grating like the blazed grating 1302 of FIG. 13 with different coatings 1102, 1304 on different surfaces, a second coating 1304, such as a reflective or refractive coating, is applied to the substrate after etching the trenches 610, as shown in FIG. 6, and prior to applying the mask to the substrate 604 that deposits mask material 606 in the trenches 610, as shown in FIG. 7. In some embodiments, the application of the second coating 1304 is self-aligned to one surface of the substrate. After removing the mask material 606 in locations 802 between the trenches 610, as shown in FIG. 8, and applying the slanted etch 902, as shown in FIG. 9, similar operations to those shown in FIGS. 11 and 12 are used to apply the first coating 1102 to the substrate 604 and remove remaining mask material 606 from the substrate 604 to produce a blazed grating 1302 in the optical substrate 504 with different coatings 1102, 1304 on different surfaces, the different coatings respectively including one of the first coating 1102 and the second coating 1304.

FIG. 14 shows an example of a blazed grating 1402 with curved surfaces 1404 in accordance with some embodiments. In this example, in order to produce the blazed grating 1402 with curved surfaces 1404, a similar operation to that shown in FIG. 9 is used, but by applying the slanted etch 902 to the substrate while varying a tilt of the substrate 604 or a direction of etching during the etching to produce the curved surfaces 1404 on the blazed grating 1402.

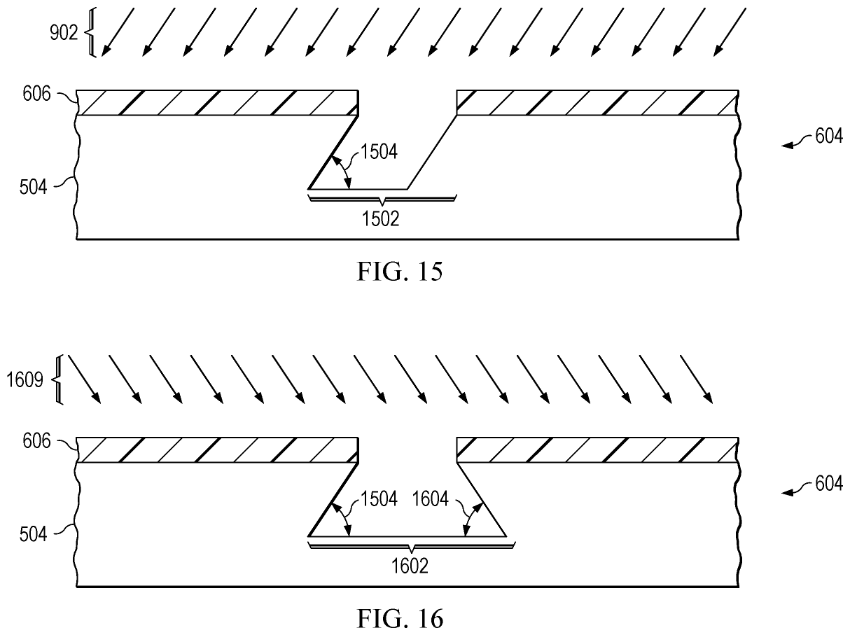

FIG. 15 shows an example step of producing a slanted grating 1502 in accordance with some embodiments, which includes etching a trench similar to the trenches 610 of FIG. 6 in the substrate 604 in the intended location of the slanted grating 1502, and then applying a slanted etch 902 to the substrate 604 to produce the slanted grating 1502 in the optical substrate 504. As shown in FIG. 15, the slanted etch 902 produces a first reentrant angle 1504 in the optical substrate 504 dependent on the angle of the slanted etch 902.

FIG. 16 shows an example of a producing a grating 1602 with reentrant profiles, i.e., an inward curving, undercut, or concave features, in accordance with some embodiments, which includes modifying a tilt of the substrate 604 or a direction of etching after producing a slanted grating 1502 like that of FIG. 15, and applying a second slanted etch 1609 to the substrate 604 to produce the grating 1602 with reentrant profiles in the optical substrate 504. As shown in FIG. 16, the second slanted etch 1609 produces a second reentrant angle 1604 in the optical substrate 504 dependent on the angle of the second slanted etch 1609. In some embodiments, the first reentrant angle 1504 and the second reentrant angle 1604 are different, depending on the particular application of the grating 1602. Additionally, it is noted that although only two periods of the blazed grating 502 are shown in FIG. 10, only two periods of the partially coated blazed grating 1202 are shown in FIG. 12, only two periods of the blazed grating 1302 with different coatings 1102, 1304 on different surfaces are shown in FIG. 13, only two periods of the blazed grating 1402 with curved surfaces 1404 are shown in FIG. 14, and only a single period of each of the slanted grating 1502 of FIG. 15 and the grating 1602 with reentrant profiles of FIG. 16 are shown in FIGS. 15 and 16, respectively, these respective gratings may be reproduced to produce gratings having any number of desired periods as required for particular applications.

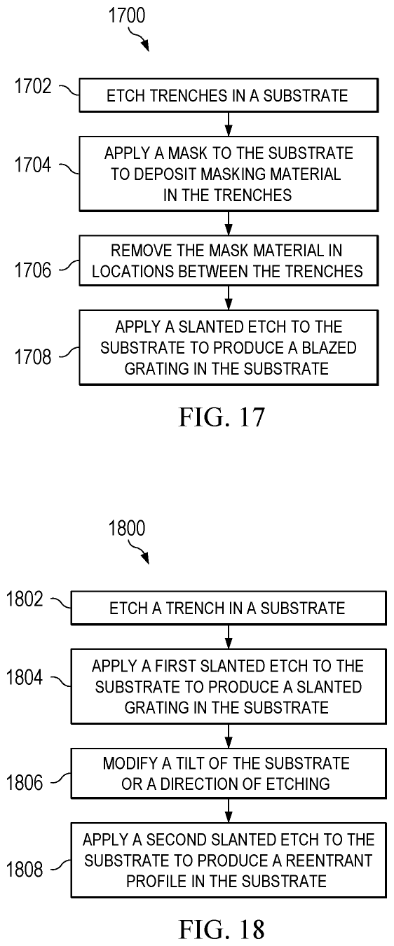

FIG. 17 shows an example method 1700 of producing a blazed grating like that of FIG. 5 in accordance with some embodiments. At block 1702, the method 1700 includes etching trenches 610 in an optical substrate 504, as shown in FIG. 6. At block 1704, the method 1700 includes applying a mask to the substrate that deposits mask material 606 in the trenches 610 formed at block 1702, as shown in FIG. 8. At block 1706, the method 1700 includes removing the mask material 606 in locations 802 between the trenches 610, as shown in FIG. 8. At block 1708, the method 1700 includes applying a slanted etch 902 to the substrate 504, as shown in FIG. 9, to produce a blazed grating 502 in the optical substrate 504, as shown in FIG. 5.

FIG. 18 shows an example method 1800 of producing a grating 1602 with reentrant profiles like that of FIG. 16 in accordance with some embodiments. At block 1802, the method 1800 includes etching a trench in an optical substrate 504, similar to the trenches 610 of FIG. 6. At block 1804, the method 1800 includes applying a first slanted etch 902 to the substrate 504 to produce a slanted grating in the substrate, as shown in FIG. 15. At block 1806, the method 1800 includes modifying a tilt of the substrate or a direction of etching, as illustrated by the change in direction between the first slanted etch 902 of FIG. 15 and the second slanted etch 1609 of FIG. 16. At block 1808, the method 1800 includes applying the second slanted etch 1609 to the substrate 504 to produce reentrant profiles in the substrate as shown in FIG. 16, where the reentrant profiles are at least in part characterized by the first reentrant angle 1504 and the second reentrant angle 1604.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
etching trenches in an optical substrate;
applying a mask to the substrate that deposits mask material in the trenches;
removing the mask material in locations between the trenches; and
applying a slanted etch to the substrate to produce a blazed grating in the substrate, wherein the slanted etching uses neutralized ion beam etching.

2. The method of claim 1, further comprising:
removing remaining mask material from the substrate; and
removing material from the substrate to flatten upper edges of the blazed grating.

3. The method of claim 1, further comprising:
applying a coating to the substrate after applying the slanted etch; and
removing remaining mask material from the substrate.

4. The method of claim 1, further comprising:
applying a first coating to the substrate after etching the trenches and prior to applying the mask.

5. The method of claim 4, further comprising:
applying a second coating to the substrate after applying the slanted etch; and
removing remaining mask material from the substrate to produce a blazed grating in the substrate with different coatings on different surfaces, the different coatings respectively comprising one of the first coating and the second coating.

6. The method of claim 1, wherein applying the slanted etch to the substrate comprises varying a tilt of the substrate or a direction of etching during the etching to produce a curved surface on the blazed grating.

7. The method of claim 1, wherein etching the trenches comprises slanted etching.

8. A method, comprising:
etching a trench in an optical substrate;
applying a first slanted etch to the substrate to produce a slanted grating in the substrate;
modifying a tilt of the substrate or a direction of etching; and
applying a second slanted etch to the substrate to produce reentrant profiles in the substrate,
wherein the slanted etching uses neutralized ion beam etching.

9. The method of claim 8, wherein the first slanted etch produces a first reentrant angle and the second slanted etch produces a second reentrant angle different from the first reentrant angle.

10. The method of claim 8, wherein etching the trench comprises slanted etching.
